(19) United States
(12) Patent Application Publication
(10) Pub. No.: US 2026/0365182 A1
(43) Pub. Date: Nov. 19, 2026

(54) SYSTEM AND METHOD FOR PREDICTING, PRE-EMPTIVELY RESPONDING TO, AND ACTIVELY RESPONDING TO A PRESENCE OF FOG IN AN ENVIRONMENT SURROUNDING A VEHICLE

(71) Applicant: GM Global Technology Operations LLC, Detroit, MI (US)

(72) Inventors: Alexander Bower, Ann Arbor, MI (US); Matthew Edward Gilbert-Eyres, Rochester Hills, MI (US); Alec M. Wuorinen, White Pigeon, MI (US)

(21) Appl. No.: 19/206,397

(22) Filed: May 13, 2025

(51) Int. Cl. B60W 50/00; B60W 30/16; B60W 30/18; B60W 50/14; G01W 1/02; G01W 1/10

(52) U.S. Cl. CPC B60W 50/0098; B60W 30/16; B60W 30/18154; B60W 50/0097; B60W 50/14; G01W 1/02; G01W 1/10; B60W 2050/0083; B60W 2050/143; B60W 2050/146; B60W 2552/30; B60W 2554/802; B60W 2555/20; B60W 2555/60; B60W 2556/45

(57) ABSTRACT

A system and method for predicting, pre-emptively responding to, and actively responding to a presence of fog in an environment surrounding a vehicle includes collecting a plurality of environmental data using a plurality of vehicle environment sensors of the vehicle, receiving weather service data from a weather service, and receiving sourced service data from a sourced service. A plurality of predictive fog score factors are determined to be present in the environment surrounding the vehicle based on the plurality of environmental data, the weather service data, and the sourced service data. The plurality of predictive fog score factors impact a predictive fog score, which is compared to a configurable threshold to determine whether the vehicle will take measures to pre-emptively respond to the fog. When a plurality of cameras of the vehicle determine fog is present in the environment, the vehicle will take measures to actively respond to the fog.

### INTRODUCTION

The present disclosure relates to a method for predicting, detecting, and responding to fog in an environment surrounding a vehicle.

The presence of fog can significantly increase the risk of operating a vehicle when present in an environment surrounding the vehicle. The fog may reduce visibility for a user of the vehicle and increase the likelihood of the vehicle being involved in a roadway accident. The user of the vehicle may take measures to mitigate the increased risk fog introduces by reducing the speed of the vehicle, activating a plurality of low beam lights or a plurality of flood lights on the vehicle, or ceasing operation of the vehicle, however, these measures are typically taken once the vehicle encounters fog in the surrounding environment.

Thus, while current measures to mitigate the increased risk fog introduces to the vehicle while in operation achieve their intended purpose, there is a need for a new and improved system and method for predicting, detecting, and responding to fog in the environment surrounding the vehicle.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for determining and pre-emptively responding to a predicted presence of fog in an environment surrounding a vehicle. The method also includes collecting a plurality of environmental data of the environment surrounding the vehicle using a plurality of vehicle environmental sensors of the vehicle; receiving a plurality of weather service data of the environment surrounding the vehicle from a weather service in communication with the vehicle; receiving a plurality of sourced service data of the environment surrounding the vehicle from a sourced service in communication with the vehicle; determining the presence of a plurality of predictive fog score factors for the vehicle based on the plurality of environmental data, the plurality of weather service data, and the plurality of sourced service data; determining a predictive fog score for the vehicle based on the presence of the plurality of predictive fog score factors; comparing the predictive fog score to a configurable threshold; and responding to the predicted presence of fog in the environment surrounding the vehicle pre-emptively. Other embodiments of this aspect include corresponding computer systems, apparatus, and computer programs recorded on one or more computer storage devices, each configured to perform the actions of the methods.

Implementations may include one or more of the following features. The method where collecting the plurality of environmental data of the environment surrounding the vehicle using the plurality of vehicle environmental sensors of the vehicle further may include the plurality of vehicle environmental sensors having a plurality of temperature sensors, a location sensor, a plurality of humidity sensors, a plurality of air pressure sensors, a plurality of cameras, and a clock. The method may include the plurality of temperature sensors collecting a plurality of temperature data of the plurality of environmental data, the location sensor collecting a plurality of positional data of the plurality of environmental data, the plurality of humidity sensors collecting a plurality of humidity data of the plurality of environmental data, the plurality of air pressure sensors collecting a plurality of air pressure data of the plurality of environmental data, the plurality of cameras collecting a plurality of visual data of the plurality of environmental data, and the clock collecting a plurality of time data of the plurality of environmental data. Determining the presence of a plurality of predictive fog score factors for the vehicle based on the plurality of environmental data, the plurality of weather service data, and the plurality of sourced service data further may include the plurality of predictive fog score factors having determining a relative humidity of the environment surrounding the vehicle is greater than 90% based on the plurality of humidity data, determining a drop in temperature in the environment surrounding the vehicle is greater than five degrees Fahrenheit between the time six hours prior to the determination of the presence of the plurality of predictive fog score factors and the time of the determination of the presence of the plurality of predictive fog score factors based on the plurality of temperature data and the plurality of time data, and determining a body of water is within five miles of the vehicle based on the plurality of positional data. Determining the presence of a plurality of predictive fog score factors for the vehicle based on the plurality of environmental data, the plurality of weather service data, and the plurality of sourced service data further may include the plurality of predictive fog score factors having determining an air pressure of the environment surrounding the vehicle is low based on the plurality of air pressure data, determining that the local time of the environment surrounding the vehicle is either between six a.m. and nine a.m. or between five p.m. and eight p.m. based on the plurality of time data, and determining that a precipitation level of the environment surrounding the vehicle is greater than two tenths of an inch between the time six hours prior to the determination of the presence of the plurality of predictive fog score factors and the time of the determination of the presence of the plurality of predictive fog score factors based on the plurality of weather service data and the plurality of time data. Determining the presence of a plurality of predictive fog score factors for the vehicle based on the plurality of environmental data, the plurality of weather service data, and the plurality of sourced service data further may include the plurality of predictive fog score factors having determining a dew point temperature of the environment surrounding the vehicle is within two to four degrees Fahrenheit of the temperature of the environment surrounding the vehicle based on the plurality of temperature data and the plurality of weather service data, determining that there are either no clouds present or only scattered clouds present in the environment surrounding the vehicle based on the plurality of weather service data, and determining a wind speed of the environment surrounding the vehicle is less than five miles per hour based on the plurality of weather service data. Determining the presence of a plurality of predictive fog score factors for the vehicle based on the plurality of environmental data, the plurality of weather service data, and the plurality of sourced service data further may include the plurality of predictive fog score factors having determining there is a local fog warning in the environment surrounding the vehicle based on the plurality of weather service data, determining an air pressure of the environment surrounding the vehicle is below 1010 hectopascals based on the plurality of air pressure data, and receiving a report from the sourced service that there is fog in the environment surrounding the vehicle based on the plurality of sourced service data. Determining the predictive fog score for the vehicle based on the presence of the plurality of predictive fog score factors further may include initializing the predictive fog score to a value of zero and adding a configured number of points to the predictive fog score for each of the plurality of predictive fog score factors present in the environment surrounding the vehicle. The method may include configuring the configurable threshold based on a plurality of arbitrary personal preferences of a user of the vehicle. Responding to the predicted presence of fog in the environment surrounding the vehicle pre-emptively further may include indicating to a user of the vehicle to increase a following distance of the vehicle based on the plurality of environmental data, the plurality of weather service data, and the plurality of sourced service data. Responding to the predicted presence of fog in the environment surrounding the vehicle pre-emptively further may include indicating to a user of the vehicle that the user should reduce the speed of the vehicle. Responding to the predicted presence of fog in the environment surrounding the vehicle pre-emptively further may include activating a defroster of the vehicle to prevent fog from obscuring the view of a user of a vehicle through a front windshield, a rear window, and a plurality of side windows of the vehicle. Implementations of the described techniques may include hardware, a method or process, or computer software on a computer-accessible medium.

One general aspect includes a method for determining and actively responding to a presence of fog in an environment surrounding a vehicle. The method also includes collecting a plurality of visual data of the environment surrounding the vehicle using a plurality of cameras of the vehicle; collecting a plurality of positional data of the environment surrounding the vehicle using a location sensor of the vehicle; determining there is the presence of fog in the environment surrounding the vehicle based on the plurality of visual data; reporting the presence of fog in the environment surrounding the vehicle to a sourced service; determining there is not a stop sign or a traffic signal on a roadway the vehicle is operating on based on the plurality of positional data; determining the fog present in the environment surrounding the vehicle is not intense based on the plurality of visual data; determining there is not an upcoming curve on the roadway the vehicle is operating on based on the plurality of positional data; determining a plurality of upcoming traffic conditions on the roadway the vehicle is operating on are not intense based on the plurality of positional data; and responding to the presence of fog in the environment surrounding the vehicle actively based on the determination there is not a stop sign or a traffic signal on the roadway the vehicle is operating on, the determination the fog present in the environment surrounding the vehicle is not intense, the determination that there is not an upcoming curve on the roadway the vehicle is operating on, and the determination that the plurality of upcoming traffic conditions on the roadway the vehicle is operating on are not intense. Other embodiments of this aspect include corresponding computer systems, apparatus, and computer programs recorded on one or more computer storage devices, each configured to perform the actions of the methods.

Implementations may include one or more of the following features. The method may include activating a plurality of speakers of the vehicle to alert a user of the vehicle that the vehicle is approaching either a stop sign or a traffic signal on a roadway the vehicle is operating on when determining there is either a stop sign or a traffic signal on the roadway the vehicle is operating on based on the plurality of positional data. The method may include activating a plurality of hazard lights of the vehicle when determining the fog present in the environment surrounding the vehicle is intense based on the plurality of visual data. The method may include indicating to a user of the vehicle to increase a following distance of the vehicle when determining there is either an upcoming curve on the roadway the vehicle is operating on based on the plurality of positional data or a plurality of upcoming traffic conditions on the roadway the vehicle is operating on are intense based on the plurality of positional data. The method may include indicating to a user of the vehicle that the user should reduce the speed of the vehicle when determining there is either an upcoming curve on the roadway the vehicle is operating on based on the plurality of positional data or a plurality of upcoming traffic conditions on the roadway the vehicle is operating on are not intense based on the plurality of positional data. Responding to the presence of fog in the environment surrounding the vehicle actively further may include activating a plurality of low beam lights or a plurality of flood lights of the vehicle. Responding to the presence of fog in the environment surrounding the vehicle actively further may include indicating to a user of the vehicle that a plurality of high beam lights of the vehicle are active when the plurality of high beam lights are active and that the plurality of high beam lights should be deactivated. Implementations of the described techniques may include hardware, a method or process, or computer software on a computer-accessible medium.

One general aspect includes a method for determining. The method also includes collecting a plurality of environmental data of the environment surrounding the vehicle using a plurality of vehicle environmental sensors of the vehicle having a plurality of temperature sensors, a location sensor, a plurality of humidity sensors, a plurality of air pressure sensors, a plurality of cameras, and a clock where the plurality of temperature sensors collect a plurality of temperature data of the plurality of environmental data, the location sensor collects a plurality of positional data of the plurality of environmental data, the plurality of humidity sensors collect a plurality of humidity data of the plurality of environmental data, the plurality of air pressure sensors collect a plurality of air pressure data of the plurality of environmental data, the plurality of cameras collect a plurality of visual data of the plurality of environmental data, and the clock collect a plurality of time data of the plurality of environmental data. Other embodiments of this aspect include corresponding computer systems, apparatus, and computer programs recorded on one or more computer storage devices, each configured to perform the actions of the methods.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for predicting, detecting, and responding to fog for a vehicle according to an exemplary embodiment;

FIG. 2 is a diagram of determining a Predictive Fog Score for the vehicle according to an exemplary embodiment;

FIG. 3 is a flowchart of a method for initiating and executing a fog pre-emptive response phase of the vehicle according to an exemplary embodiment; and

FIG. 4 is a flowchart of a method for executing a fog safe response phase of the vehicle according to an exemplary embodiment.

### DETAILED DESCRIPTION

The following description is merely exemplary in nature and is not intended to limit the present disclosure, application, or uses.

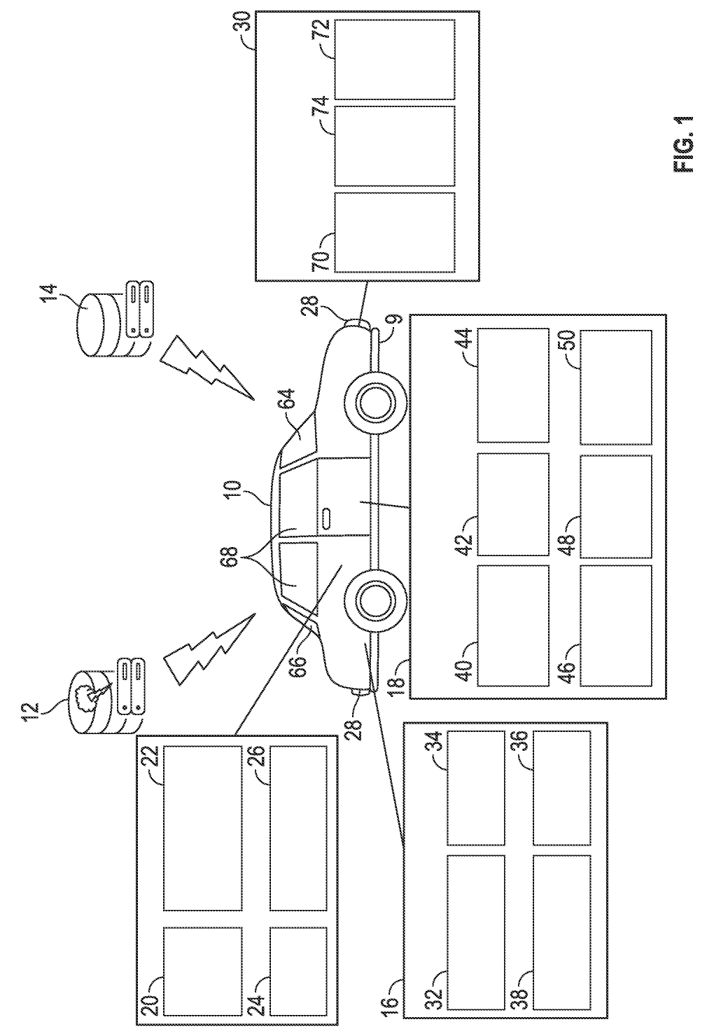

Referring to FIG. 1, a schematic diagram of a system 9 for predicting, detecting, and responding to fog for a vehicle 10 is shown. The system 9 generally includes the vehicle 10, a weather service 12, and a sourced service 14.

The vehicle 10 is a land vehicle such as a car, truck, etc. that can be operated by a user or by an autonomous driving module. The vehicle 10 may have various levels of driving automation, including Level Five, Level Four, Level Three, and Level Two automation. For example, a Level Five system indicates “full automation,” referring to the full-time performance by an automated driving system of aspects of the dynamic driving task under a number of roadway and environmental conditions that can be managed by a human driver. A Level Four system indicates “high automation,” referring to the driving mode-specific performance by an automated driving system of aspects of the dynamic driving task, even if a human driver does not respond appropriately to a request to intervene. In Level Three vehicles, the vehicle systems perform the entire dynamic driving task (DDT) within the area that it is designed to do so. The vehicle operator is only expected to be responsible for the DDT-fallback when the vehicle 10 essentially “asks” the driver to take over if something goes wrong or the vehicle is about to leave the zone where it is able to operate. In Level Two vehicles, systems provide steering, brake/acceleration support, lane centering, and adaptive cruise control. However, even if these systems are activated, the vehicle operator at the wheel must be driving and constantly supervising the automated features. The vehicle 10 may include various actuator devices (not shown) used to achieve the above-described levels of automation. The actuator devices control one or more vehicle features including, but not limited to, a propulsion system, a transmission system, a steering system, and a brake system (not shown). In various embodiments, the vehicle features may further include interior and/or exterior vehicle features such as, but are not limited to, doors, a trunk, and cabin features such as air, music, lighting, etc. In the particular example provided in FIG. 1, the vehicle 10 includes a controller 16, a plurality of vehicle environment sensors 18, a defroster 20, a plurality of vehicle operation sensors 22, a display 24, a plurality of speakers 26, a plurality of hazard lights 28, and a plurality of front lights 30.

The controller 16 is a non-generalized, electronic control device having a preprogrammed digital computer or processor 32, a memory 34, a transceiver 36, and a plurality of input and output ports 38. The processor 32 may be a custom made or commercially available processor, a central processing unit (CPU), a graphics processing unit (GPU), an auxiliary processor among several processors associated with the controller 16, a semiconductor-based microprocessor (in the form of a microchip or chip set), a microprocessor, a combination thereof, or generally a device for executing instructions. The memory 34 is used to store data such as control logic, software applications, instructions, computer code, data, lookup tables, etc. The memory 34 includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code. The processor 32 is configured to execute the code or instructions.

The transceiver 36 is configured to wirelessly communicate with a hotspot using Wi-Fi protocols under IEEE 802.11x standards. The transceiver 36 is also configured to wirelessly communicate using cellular data communication under GSMA standards, such as SGP.02, SGP.22, SGP.32 and the like. Suitably, the vehicle 10 may further include an embedded universal integrated circuit card (eUICC) configured to store at least one cellular connectivity configuration profile, for example, an embedded subscriber identity module (eSIM) profile. The transceiver 36 is further configured to communicate via a personal area network (e.g., BLUETOOTH), near-field communication (NFC), and/or any additional type of radiofrequency communication.

The plurality of input and output ports 38 receive incoming data from the plurality of vehicle environment sensors 18 and communicate the incoming data to the processor 32. The plurality of input and output ports 38 also receive outgoing data from the processor 32 and communicate the outgoing data to the plurality of vehicle environment sensors 18. The plurality of input and output ports 38 are configured to wirelessly communicate with the plurality of vehicle environment sensors 18 via the transceiver 36 and are also configured to communicate with the plurality of vehicle environment sensors 18 through a Universal Serial Bus (USB) wired connection.

The controller 16 may further include one or more applications. The application is a software program configured to perform a specific function or set of functions. The applications may include one or more computer programs, software components, sets of instructions, procedures, functions, objects, classes, instances, related data, or a portion thereof adapted for implementation in a suitable computer readable program code. The applications may be stored within the memory 34 or in additional or separate memory.

The controller 16 is in electrical communication with the plurality of vehicle environment sensors 18. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 16 are within the scope of the present disclosure.

The plurality of vehicle environment sensors 18 are located within the vehicle 10 and are used to acquire a plurality of environmental data 39 of an environment surrounding the vehicle 10. In a non-limiting list of examples, the plurality of environmental data 39 may include the temperature, position, air pressure, humidity, time of day, and appearance of the environment surrounding the vehicle 10. In an exemplary embodiment, the plurality of vehicle environment sensors 18 has a plurality of temperature sensors 40, a location sensor 42, a plurality of humidity sensors 44, a plurality of air pressure sensors 46, a plurality of cameras 48, and a clock 50. The plurality of environmental data 39 includes the data received by the plurality of temperature sensors 40, the location sensor 42, the plurality of humidity sensors 44, the plurality of air pressure sensors 46, the plurality of cameras 48, and the clock 50.

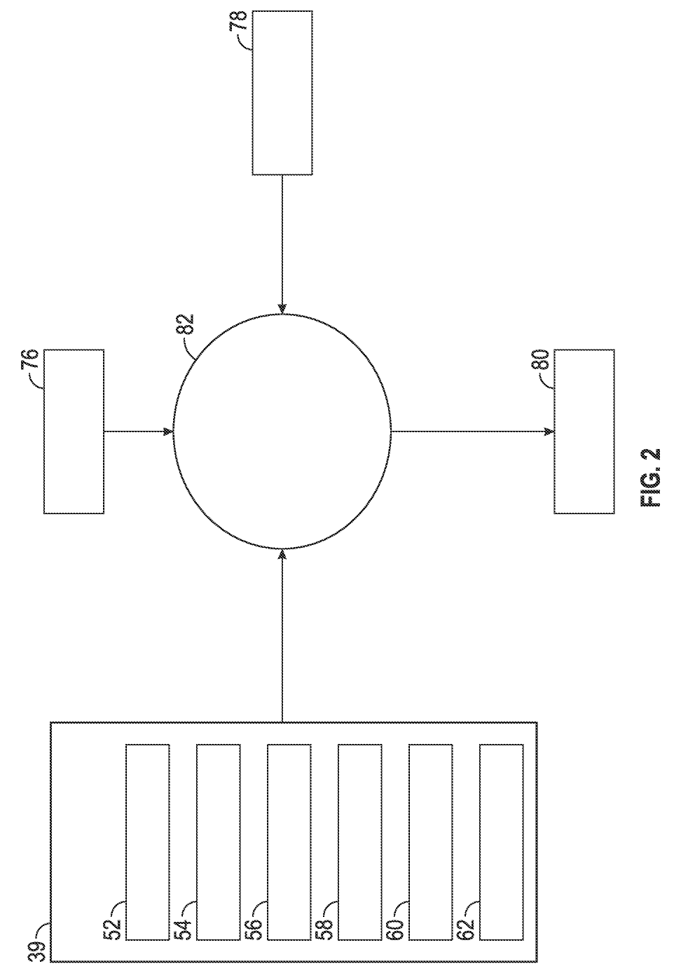

Referring to FIG. 1 and FIG. 2, the plurality of temperature sensors 40 are located throughout the exterior of the vehicle 10 and receive a plurality of temperature data 52 from the environment surrounding the vehicle 10. In a non-limiting list of examples, the plurality of temperature sensors 40 may have thermometers, semiconductor sensors, and infrared sensors. The plurality of temperature data 52 is then communicated to the processor 32 to assist in predicting the likelihood the vehicle 10 will encounter fog while in operation.

The location sensor 42 is located within the vehicle 10 and receives a plurality of positional data 54 of the environment surrounding the vehicle 10. In a non-limiting list of examples, the plurality of positional data 54 may be represented as a set of geographic coordinates in a two-dimensional cartesian coordinate system having a latitude and a longitude, a set of geographic coordinates in a three-dimensional cartesian coordinate system having a latitude, longitude, and altitude, a set of Universal Transverse Mercator (UTM) coordinates having an easting coordinate and a northing coordinate, a set of State Plane Coordinates (SPC), and a set of polar coordinates. The plurality of positional data 54 may also include roadways, features of roadways including curves and intersections, stop signs, traffic signals, traffic conditions of roadways, and other points of interest in the environment surrounding the vehicle 10. It should be appreciated that the plurality of positional data 54 can determine the intensity of traffic conditions of roadways based on a congestion of the roadway, where the traffic conditions are “intense” when there is a high degree of congestion on the roadway. The plurality of positional data 54 is then communicated to the processor 32 to assist in predicting the likelihood the vehicle 10 will encounter fog while in operation.

The plurality of humidity sensors 44 are located on the exterior of the vehicle 10 and receive a plurality of humidity data 56 from the environment surrounding the vehicle 10. In a non-limiting list of examples, the plurality of humidity sensors 44 may have capacitive humidity sensors, resistive humidity sensors, thermal conductivity humidity sensors, optical humidity sensors, gravimetric humidity sensors, and psychrometers. The plurality of humidity data 56 represents a maximum amount of moisture the environment surrounding the vehicle 10 can hold at the temperature measured by the plurality of temperature sensors 40 (also called the relative humidity). The plurality of humidity data 56 is then communicated to the processor 32 to assist in predicting the likelihood the vehicle 10 will encounter fog while in operation.

The plurality of air pressure sensors 46 are located on the exterior of the vehicle 10 and receive a plurality of air pressure data 58 from the environment surrounding the vehicle 10. In a non-limiting example, the plurality of air pressure sensors 46 may have barometers. The plurality of air pressure data 58 represents the measured air pressure of the environment surrounding the vehicle 10 and is classified into three main categories: “low” air pressure (where the measured air pressure is below 1013 hectopascals (hPa), “standard” air pressure (where the measured air pressure is around 1013 hPa), and “high” air pressure (where the measured air pressure is above 1020 hPa). The plurality of air pressure data 58 is then communicated to the processor 32 to assist in predicting the likelihood the vehicle 10 will encounter fog while in operation.

The plurality of cameras 48 are located throughout the exterior of the vehicle 10 and receive a plurality of visual data 60 from the environment surrounding the vehicle 10. The plurality of visual data 60 is then communicated to the processor 32 to assist in determining whether fog is present in the environment surrounding the vehicle 10 using a machine-learning algorithm. The machine-learning algorithm can also be used to determine whether the fog present in the environment surrounding the vehicle 10 is “intense” based on the distance the plurality of cameras 48 can observe other objects in the environment surrounding the vehicle 10. In a non-limiting exemplary embodiment, the fog present in the environment surrounding the vehicle 10 is “light” when the plurality of cameras 48 can observe other objects past six tenths of a mile away, is “moderate” when the plurality of cameras 48 can observe other objects up to six tenths of a mile away, and is “intense” when the plurality of cameras 48 can observe other objects up to three tenths of a mile away.

The clock 50 assists the controller 16 in accurately tracking the time of day local to the environment surrounding the vehicle 10 in hours, minutes, seconds, and milliseconds (hereinafter referred to as a plurality of time data 62). The plurality of time data 62 is then communicated to the processor 32 to assist in predicting the likelihood the vehicle 10 will encounter fog while in operation. The plurality of environmental data 39 of the environment surrounding the vehicle 10 includes the plurality of time data 62.

Returning to FIG. 1, the defroster 20 is situated at the periphery of a front windshield 64 of the vehicle 10 and removes frost, ice, and condensation from the front windshield 64. The defroster 20 also mitigates and prevents fog that may obstruct visibility through the front windshield 64 by directing warm air generated by a heating, ventilation, and air conditioning (HVAC) unit in the vehicle 10 onto the front windshield 64. The defroster 20 may further mitigate and prevent fog by generating and dispersing cool air using the HVAC unit throughout the interior of the vehicle 10, removing excess moisture from the air inside the vehicle 10. The defroster 20 may be activated manually by a user operating the vehicle 10 or activated autonomously by the controller 16. In a different exemplary embodiment, there may a plurality of defrosters situated at the periphery of a plurality of windows of the vehicle 10 having the front windshield 64, a rear window 66, and a plurality of side windows 68.

The plurality of vehicle operation sensors 22 are located throughout the exterior of the vehicle 10 and assist the controller 16 in maintaining a following distance of the vehicle 10. The following distance of the vehicle 10 is a distance the vehicle 10 can be from another vehicle immediately in front of the vehicle 10 (referred to as the leading vehicle 10). The following distance is regulated by the controller 16 based on a plurality of following data received by the plurality of vehicle operation sensors 22, preventing the vehicle 10 from achieving a closer distance to the leading vehicle 10 than the following distance. The following distance may be set manually by the user of the vehicle 10 or may be set automatically by the controller 16 based on the plurality of environmental data 39 received by the controller 16. The following distance may also be increased or decreased either manually or automatically throughout the operation of the vehicle 10. In an exemplary embodiment, the plurality of vehicle operation sensors 22 has a plurality of radar sensors, a plurality of ultrasonic sensors, and a plurality of light detection and ranging (LIDAR) sensors. The plurality of vehicle operation sensors 22 may also receive the plurality of visual data 60 observed by the plurality of cameras 48 to assist the controller 16 in maintaining the following distance of the vehicle 10.

The display 24 is a screen that is located within the vehicle 10 that has a human-machine interface that presents the plurality of temperature data 52, plurality of positional data 54, plurality of humidity data 56, plurality of air pressure data 58, plurality of visual data 60, and plurality of time data 62 received by the plurality of vehicle environment sensors 18. The display 24 also allows the user to configure the vehicle 10, and run the applications included in the controller 16.

The plurality of speakers 26 are situated throughout the interior of the vehicle 10 and provide audio alerts for functions of the vehicle 10. In a non-limiting list of examples, the audio alerts include alerting the user that a seatbelt in the vehicle 10 has not been engaged, that a fuel level of the vehicle 10 is “low”, and that there is an obstacle along a roadway the vehicle 10 is operating on, including fog. In a non-limiting list of examples, the plurality of speakers 26 may include tweeters, mid-range speakers, woofers, and subwoofers.

The plurality of hazard lights 28 are situated in the front and rear exterior of the vehicle 10 that repeatedly flash while activated. The plurality of hazard lights 28 are used to signal emergencies or warn of obstacles along a roadway the vehicle 10 is operating on. The plurality of hazard lights 28 may be activated manually by a user operating the vehicle 10 or activated autonomously by the controller 16.

The plurality of front lights 30 are situated in the front exterior of the vehicle 10 and illuminate an area in front of the vehicle 10 when activated, allowing for increased visibility for the user while operating the vehicle 10. The plurality of front lights 30 include a plurality of low beam lights 70, a plurality of flood lights 72, and a plurality of high beam lights 74. The plurality of low beam lights 70 are lights that have a short and wide beam pattern that can illuminate an area directly in front of the vehicle 10 without generating glare for oncoming traffic. The plurality of flood lights 72 are lights that have a wide, dispersed beam pattern that can light up a broad area around the vehicle 10. The plurality of high beam lights 74 are lights that have a long and narrow beam pattern that can illuminate a farther area in front of the vehicle 10 compared to the plurality of low beam lights 70 and the plurality of flood lights 72. The plurality of high beam lights 74 may generate glare for oncoming traffic. It should be appreciated that the plurality of flood lights 72 are optional, meaning that the vehicle may not have the plurality of flood lights 72.

Referring to FIG. 1 and FIG. 2, the weather service 12 is a service used to communicate a plurality of weather service data 76 of the environment surrounding the vehicle 10 to the controller 16. In an exemplary embodiment, the weather service 12 is a computerized database that may communicate the plurality of weather service data 76 via satellite, a cellular network, or a local area network. The plurality of weather service data 76 may have, in a non-limiting list of examples, data relating to the temperature, humidity, wind chill, wind speed, air pressure, dew point temperature, air temperature convergence, cloud presence, and precipitation levels of the environment surrounding the vehicle 10, as well as of other environments not surrounding the vehicle 10.

The sourced service 14 is a service where a plurality of users having a plurality of devices may report the presence of obstacles, including fog, proximate to a location of the respective user via a human-machine interface. The report is communicated to and processed by a centralized sourced service server and is then delivered to the plurality of devices, which are in communication with the centralized sourced service server. The plurality of users may also provide feedback on the report, either verifying the presence of the obstacle in the location or noting an absence of the obstacle in the location. It should be appreciated that the reports of obstacles made to the centralized sourced service server are referred to as a plurality of sourced service data 78. In an exemplary embodiment, the vehicle 10 may be a device in communication with the centralized sourced service server that receives the report of fog in or near the environment surrounding the vehicle 10 and indicates the presence of fog via the display 24. In another exemplary embodiment, a user of the vehicle 10 may report the presence of fog to the centralized sourced service server via the display 24 to be delivered to the plurality of devices in communication with the centralized sourced service server.

Referring to FIG. 2, a diagram of determining a Predictive Fog Score (PFS) 80 for the vehicle 10 is shown. The PFS 80 is a variable that corresponds to the likelihood the vehicle 10 may encounter fog while in operation based on a plurality of PFS factors 82, predicting the presence of fog in the environment surrounding the vehicle 10. The PFS 80 is initialized to a value of zero where points are added based on the presence of at least one of the plurality of PFS factors 82. The PFS 80 is compared to a configurable threshold to determine whether the vehicle 10 should enter a fog pre-emptive response phase to mitigate the risk predicted fog poses for the vehicle 10 while in operation. The configurable threshold is an arbitrary value that is determined based on a plurality of arbitrary personal preferences of a user of the vehicle 10. The plurality of PFS factors 82 are determined to be present based on the environmental data of the environment surrounding the vehicle 10 received by the plurality of vehicle environment sensors 18.

The plurality of PFS factors 82 include determining a relative humidity of the environment surrounding the vehicle 10 is greater than 90%, which is based on the received plurality of humidity data 56. When the humidity of the environment surrounding the vehicle 10 is greater than 90%, one point is added to the PFS 80. The plurality of PFS factors 82 also includes determining a drop in temperature in the environment surrounding the vehicle 10 is greater than five degrees Fahrenheit between the time six hours prior to the PFS 80 being determined and the time the PFS 80 is determined, which is based on the received plurality of temperature data 52 and plurality of time data 62. When a drop in temperature in the environment surround the vehicle 10 is greater than five degrees Fahrenheit, one point is added to the PFS 80. The plurality of PFS factors 82 also includes determining a body of water is within five miles of the vehicle 10, which is based on the received plurality of positional data 54. When a body of water is within five miles of the vehicle 10, two points are added to the PFS 80.

The plurality of PFS factors 82 also includes determining an air pressure of the environment surrounding the vehicle 10 is “low”, which is based on the received plurality of air pressure data 58. When the air pressure of the environment surrounding the vehicle 10 is “low”, one point is added to the PFS 80. The plurality of PFS factors 82 also includes determining that the plurality of time data 62 indicates that local time of the environment surrounding the vehicle 10 is between six A.M. and nine A.M. or between five P.M. and eight P.M., which is based on the received plurality of time data 62. When the local time is between six A.M. and nine A.M. or between five P.M. and eight P.M., two points are added to the PFS 80. The plurality of PFS factors 82 also includes determining that a precipitation level of the environment surrounding the vehicle 10 is greater than two tenths of an inch between the time six hours prior to the PFS 80 being determined and the time the PFS 80 is determined, which is based on the received plurality of weather service data 76 and plurality of time data 62. When the precipitation level of the environment surrounding the vehicle 10 is greater than two tenths of an inch, two points are added to the PFS 80.

The plurality of PFS factors 82 also include determining that a dew point temperature of the environment surrounding the vehicle 10 is within two to four degrees Fahrenheit of the temperature measured by the plurality of temperature sensors 40, which is based on the received plurality of weather service data 76 and plurality of temperature data 52. When the dew point temperature of the environment surrounding the vehicle 10 is within two to four degrees Fahrenheit of the temperature measured by the plurality of temperature sensors 40, two points are added to the PFS 80. The plurality of PFS factors 82 also include determining that there are no clouds present or only scattered clouds present in the environment surrounding the vehicle 10, which is based on the received plurality of weather service data 76. When there are no clouds present or only scattered clouds present in the environment surrounding the vehicle 10, one point is added to the PFS 80. The plurality of PFS factors 82 also include determining that a wind speed of the environment surrounding the vehicle 10 is less than five miles per hour (mph), which is based on the received plurality of weather service data 76. When the wind speed of the environment surrounding the vehicle 10 is less than five mph, one point is added to the PFS 80.

The plurality of PFS factors 82 also include determining there is a local fog warning in the environment surrounding the vehicle 10, which is based on the received plurality of weather service data 76. When there is a local fog warning in the environment surrounding the vehicle 10, three points are added to the PFS 80. The plurality of PFS factors 82 also include determining an air pressure of the environment surrounding the vehicle 10 is below 1010 hPa, which is based on the plurality of air pressure data 58. When the air pressure of the environment surrounding the vehicle 10 is below 1010 hPa, two points are added to the PFS 80. The plurality of PFS factors 82 also include receiving a report from the sourced service 14 that there is fog in the environment surrounding the vehicle 10. When a report is received from the sourced service 14 that there is fog in the environment surrounding the vehicle 10, three points are added to the PFS 80.

It should be appreciated that the number of points added to the PFS 80 for each of the plurality of PFS factors 82 is configurable number based on the plurality of arbitrary personal preferences of the user of the vehicle 10. It should also be appreciated that the humidity, temperature, distance, time, air pressure, and wind speed ranges that are detailed in the plurality of PFS factors 82 are configurable based on the plurality of arbitrary personal preferences of the user of the vehicle 10.

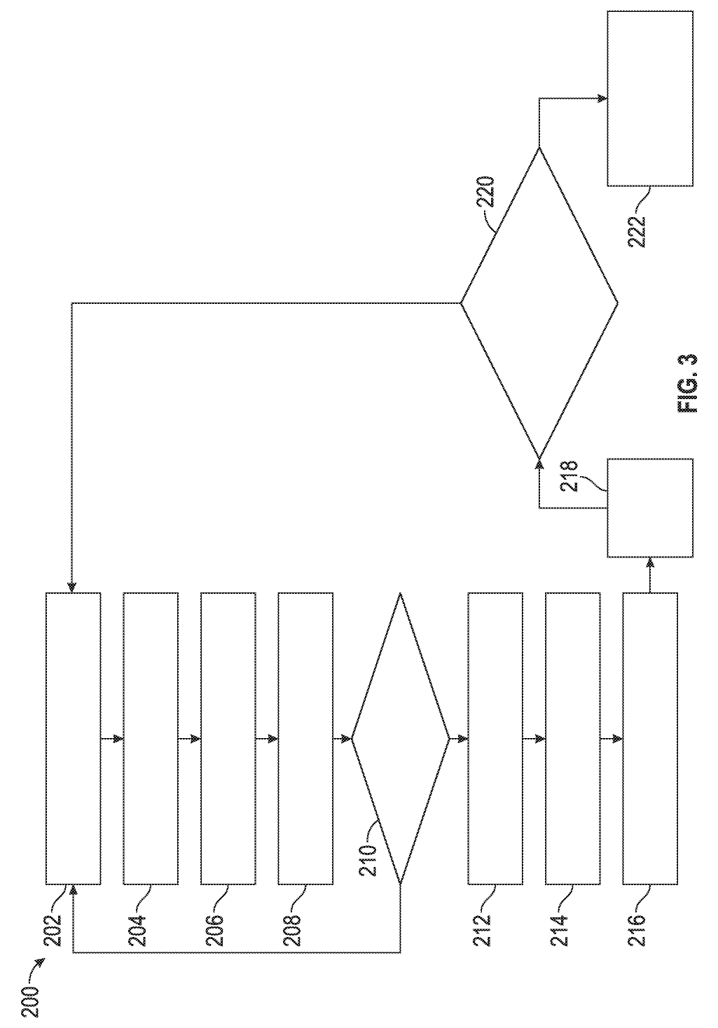

Referring to FIG. 3, a flowchart of a method for initiating and executing the fog pre-emptive response phase of the vehicle 10 is generally indicated by reference number 200. The method 200 begins at step 202, where the plurality of vehicle environment sensors 18 collect the plurality of environmental data 39 of the environment surrounding the vehicle 10. The method 200 then proceeds to step 204.

At step 204, the controller 16 receives the plurality of weather service data 76 from the weather service 12 via the transceiver 36. The method 200 then proceeds to step 206.

At step 206, the controller 16 receives the plurality of sourced service data 78 from the sourced service 14 via the transceiver 36. The method 200 then proceeds to step 208.

At step 208, the PFS 80 is determined based on the plurality of PFS factors 82 determined to be present in the environment surrounding the vehicle 10 based on the plurality of environmental data 39, the plurality of weather service data 76, and the plurality of sourced service data 78. The method 200 then proceeds to step 210.

At step 210, the PFS 80 is compared to the configurable threshold. When the PFS 80 is greater than the configurable threshold, the method 200 then proceeds to step 212.

At step 212, the controller 16 indicates the fog pre-emptive response phase of the vehicle 10 has been initiated via the display 24. The method 200 then proceeds to step 214.

At step 214, the controller 16 indicates via the display 24 that the following distance of the vehicle 10 should be increased by the user based on the plurality of environmental data 39 received by the plurality of vehicle environment sensors 18. In an exemplary embodiment where the autonomous driving module of the vehicle 10 is engaged in Level Two automation or above, the controller 16 automatically increases the following distance of the vehicle 10 without input from the user. The method 200 then proceeds to step 216.

At step 216, the controller 16 indicates to the user of the vehicle 10 via the display 24 that the user should reduce the speed of the vehicle 10. In an exemplary embodiment where the autonomous driving module of the vehicle 10 is engaged in Level Two automation or above, the controller 16 automatically reduces the rate of speed of the vehicle 10 without input from the user. The method 200 then proceeds to step 218.

At step 218, the controller 16 activates the defroster 20 to prevent fog from obscuring the view of the user through the front windshield 64, the rear window 66, and the plurality of side windows 68. The method 200 then proceeds to step 220.

At step 220, the controller 16 determines whether the plurality of visual data 60 received by the plurality of cameras 48 indicates the presence of fog in the environment surrounding the vehicle 10 using a machine learning model. When the controller 16 determines that the plurality of visual data 60 indicates the presence of fog, the method 200 then proceeds to step 222.

At step 222, a fog safe response phase of the vehicle 10 is initiated and executed.

Returning to step 210, when the PFS 80 is less than or equal to the configurable threshold, the vehicle 10 continues operation without the controller 16 initiating and executing the fog pre-emptive response phase of the vehicle 10. The method 200 then proceeds to step 202.

Returning to step 220, when the controller 16 does not determine that the plurality of visual data 60 indicates the presence of fog in the environment surrounding the vehicle 10, the method 200 then proceeds to step 202.

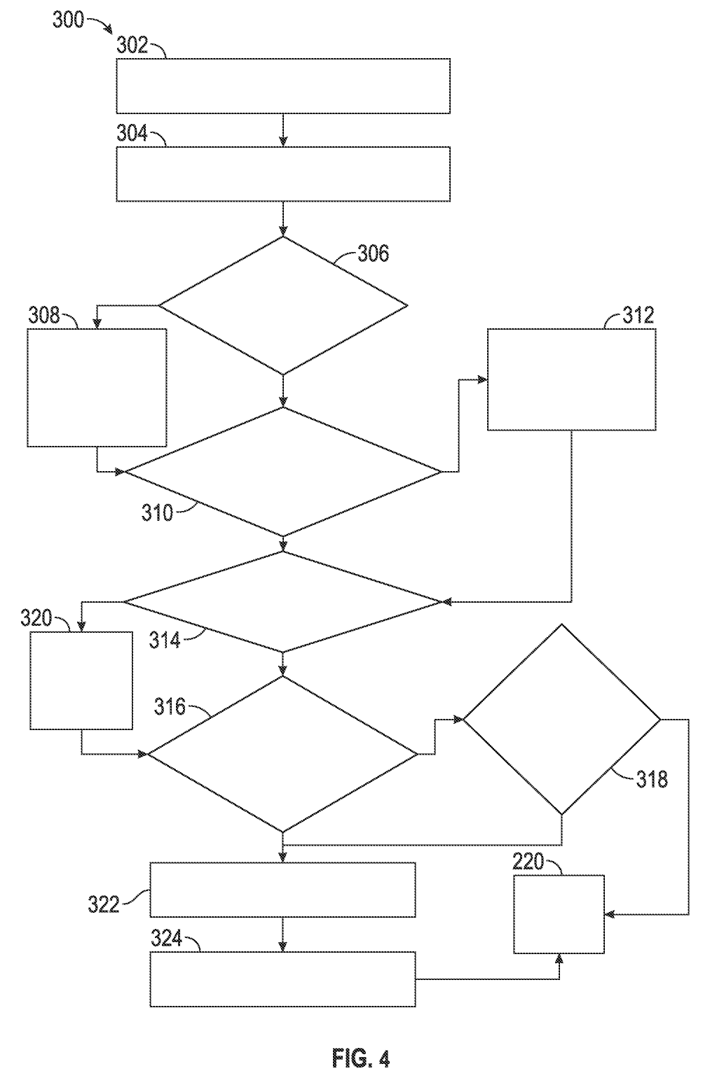

Referring to FIG. 4, a flowchart of a method for executing the fog safe response phase of the vehicle 10 is generally indicated by reference number 300. The method 300 begins at step 302, where the controller 16 reports the presence of fog in the environment surrounding the vehicle 10 to the sourced service 14 based on the plurality of visual data 60 received by the plurality of cameras 48 in step 220 of the method 200. The method 300 then proceeds to step 304.

At step 304, the controller 16 activates the either the plurality of low beam lights 70 or the plurality of flood lights 72. The method 300 then proceeds to step 306.

At step 306, the controller 16 determines whether the plurality of high beam lights 74 are active. When the plurality of high beam lights 74 are active, the method 300 then proceeds to step 308.

At step 308, the controller 16 indicates to the user via the display 24 that the plurality of high beam lights 74 are active and suggests to the user to deactivate the plurality of high beam lights 74. The method 300 then proceeds to step 310.

At step 310, the controller 16 determines whether the vehicle 10 is approaching a stop sign or a traffic signal based on the plurality of positional data 54 and the plurality of visual data 60 received by the location sensor 42 and the plurality of cameras 48 respectively. When the controller 16 determines the vehicle 10 is approaching a stop sign or a traffic signal, the method 300 then proceeds to step 312.

At step 312, the controller 16 activates the plurality of speakers 26 to alert the user that the vehicle 10 is approaching a stop sign or a traffic signal. The method 300 then proceeds to step 314.

At step 314, the controller 16 determines whether the fog indicated to be present in the environment surrounding the vehicle 10 in step 222 of the method 200 is “intense” based on the plurality of visual data 60 received by the plurality of cameras 48. When the fog indicated to be present in the environment surrounding the vehicle 10 in step 222 of the method 200 is not “intense”, the method 300 then proceeds to step 316.

At step 316, the controller 16 determines whether there is an upcoming curve on a roadway the vehicle 10 is operating on based on the plurality of positional data 54 received by the location sensor 42. When there is not an upcoming curve on the roadway the vehicle 10 is operating on, the method 300 then proceeds to step 318.

At step 318, the controller 16 determines whether the upcoming traffic conditions on the roadway the vehicle 10 is operating on are “intense” based on the plurality of positional data 54 received by the location sensor 42. When the upcoming traffic conditions on the roadway the vehicle 10 is operating on are not “intense”, the method 300 then proceeds to step 220 of the method 200.

Returning to step 306, when the plurality of high beam lights 74 are not active, the method 300 then proceeds to step 310.

Returning to step 310, when the controller 16 determines the vehicle 10 is not approaching a stop sign or a traffic signal, the method 300 then proceeds to step 314.

Returning to step 314, when the fog indicated to be present in the environment surrounding the vehicle 10 in step 222 of the method 200 is “intense”, the method 300 then proceeds to step 320.

At step 320, the controller activates the plurality of hazard lights 28 of the vehicle 10. The method 300 then proceeds to step 316.

Returning to step 316, when there is an upcoming curve on the roadway the vehicle 10 is operating on, the method 300 then proceeds to step 322.

At step 322, the controller 16 indicates via the display 24 that the following distance of the vehicle 10 should be increased by the user. In an exemplary embodiment where the autonomous driving module of the vehicle 10 is engaged in Level Two automation or above, the controller 16 automatically increases the following distance of the vehicle 10 without input from the user. The method 300 then proceeds to step 324.

At step 324, the controller 16 indicates to the user of the vehicle 10 via the display 24 that the user should reduce the speed of the vehicle 10. In an exemplary embodiment where the autonomous driving module of the vehicle 10 is engaged in Level Two automation or above, the controller 16 automatically reduces the rate of speed of the vehicle 10 without input from the user. The method 300 then proceeds to step 220 of the method 200.

Returning to step 318, when the upcoming traffic conditions on the roadway the vehicle 10 is operating on are “intense”, the method 300 then proceeds to step 322.

The system 9, method 200, and method 300 of the present disclosure offer several advantages. One such advantage is the ability of the vehicle 10 to predict the presence of fog in the environment surrounding the vehicle 10 via the PFS 80 before the vehicle 10 encounters the fog, alerting the user of the vehicle 10 to the potentially dangerous driving conditions the user may experience while operating the vehicle 10 due to the presence of the fog. Another such advantage is the ability of the vehicle 10 to have different phases of response to the presence of fog in the environment surrounding the vehicle 10 through executing the fog pre-emptive response phase and the fog safe response phase, increasing the extent of the response to the fog through each subsequential phase.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for determining and pre-emptively responding to a predicted presence of fog in an environment surrounding a vehicle, the method comprising:
collecting a plurality of environmental data of the environment surrounding the vehicle using a plurality of vehicle environment sensors of the vehicle;
receiving a plurality of weather service data of the environment surrounding the vehicle from a weather service in communication with the vehicle;
receiving a plurality of sourced service data of the environment surrounding the vehicle from a sourced service in communication with the vehicle;
determining a presence of a plurality of predictive fog score factors for the vehicle based on the plurality of environmental data, the plurality of weather service data, and the plurality of sourced service data;
determining a predictive fog score for the vehicle based on the presence of the plurality of predictive fog score factors;
comparing the predictive fog score to a configurable threshold; and
initiating a fog pre-emptive response phase for the vehicle in response to determining that the predictive fog score exceeds the configurable threshold, wherein the fog pre-emptive response phase includes activating a defroster of the vehicle to prevent fog from obscuring a view of a user of the vehicle through a front windshield, a rear window, and a plurality of side windows of the vehicle.

2. The method of claim 1, wherein collecting the plurality of environmental data of the environment surrounding the vehicle using the plurality of vehicle environment sensors of the vehicle further comprises using the plurality of vehicle environment sensors and a clock of the vehicle, the plurality of vehicle environment sensors having a plurality of temperature sensors, a location sensor, a plurality of humidity sensors, a plurality of air pressure sensors, and a plurality of cameras.

3. The method of claim 2 wherein collecting the plurality of environmental data of the environment surrounding the vehicle using the plurality of vehicle environment sensors of the vehicle further comprises the plurality of temperature sensors collecting a plurality of temperature data of the plurality of environmental data, the location sensor collecting a plurality of positional data of the plurality of environmental data, the plurality of humidity sensors collecting a plurality of humidity data of the plurality of environmental data, the plurality of air pressure sensors collecting a plurality of air pressure data of the plurality of environmental data, the plurality of cameras collecting a plurality of visual data of the plurality of environmental data, and the clock recording a plurality of time data of the plurality of environmental data.

4. The method of claim 3, wherein determining the presence of the plurality of predictive fog score factors for the vehicle based on the plurality of environmental data, the plurality of weather service data, and the plurality of sourced service data further comprises the plurality of predictive fog score factors having determining a relative humidity of the environment surrounding the vehicle is greater than 90% based on the plurality of humidity data, determining a drop in temperature in the environment surrounding the vehicle is greater than five degrees Fahrenheit between the time six hours prior to the determination of the presence of the plurality of predictive fog score factors and the time of the determination of the presence of the plurality of predictive fog score factors based on the plurality of temperature data and the plurality of time data, and determining a body of water is within five miles of the vehicle based on the plurality of positional data.

5. The method of claim 3, wherein determining the presence of the plurality of predictive fog score factors for the vehicle based on the plurality of environmental data, the plurality of weather service data, and the plurality of sourced service data further comprises the plurality of predictive fog score factors having determining an air pressure of the environment surrounding the vehicle is “low” based on the plurality of air pressure data, determining that a local time of the environment surrounding the vehicle is either between six A.M. and nine A.M. or between five P.M. and eight P.M. based on the plurality of time data, and determining that a precipitation level of the environment surrounding the vehicle is greater than two tenths of an inch between the time six hours prior to the determination of the presence of the plurality of predictive fog score factors and the time of the determination of the presence of the plurality of predictive fog score factors based on the plurality of plurality of weather service data 76 and the plurality of time data.

6. The method of claim 3, wherein determining the presence of the plurality of predictive fog score factors for the vehicle based on the plurality of environmental data, the plurality of weather service data, and the plurality of sourced service data further comprises the plurality of predictive fog score factors having determining a dew point temperature of the environment surrounding the vehicle is within two to four degrees Fahrenheit of a temperature of the environment surrounding the vehicle based on the plurality of temperature data and the plurality of weather service data, determining that there are either no clouds present or only scattered clouds present in the environment surrounding the vehicle based on the plurality of weather service data, and determining a wind speed of the environment surrounding the vehicle is less than five miles per hour based on the plurality of weather service data.

7. The method of claim 3, wherein determining the presence of the plurality of predictive fog score factors for the vehicle based on the plurality of environmental data, the plurality of weather service data, and the plurality of sourced service data further comprises the plurality of predictive fog score factors having determining there is a local fog warning in the environment surrounding the vehicle based on the plurality of weather service data, determining an air pressure of the environment surrounding the vehicle is below 1010 hectopascals based on the plurality of air pressure data, and determining that the plurality of sourced service data includes a report indicating that there is fog in the environment surrounding the vehicle.

8. The method of claim 1, wherein determining the predictive fog score for the vehicle based on the presence of the plurality of predictive fog score factors further comprises initializing the predictive fog score to a value of zero and adding a configurable number of points to the predictive fog score for each of the plurality of predictive fog score factors present in the environment surrounding the vehicle.

9. The method of claim 1 further comprising configuring the configurable threshold based on a plurality of arbitrary personal preferences of a user of the vehicle.

10. The method of claim 1, wherein initiating a fog pre-emptive response phase for the vehicle further comprises indicating to a user of the vehicle to increase a following distance of the vehicle based on the plurality of environmental data, the plurality of weather service data, and the plurality of sourced service data.

11. The method of claim 1, wherein initiating a fog pre-emptive response phase for the vehicle further comprises indicating to a user of the vehicle that the user should reduce a speed of the vehicle.

12. (canceled)

13. A method for determining and actively responding to a presence of fog in an environment surrounding a vehicle, the method comprising:
collecting a plurality of visual data of the environment surrounding the vehicle using a plurality of cameras of the vehicle;
collecting a plurality of positional data of the environment surrounding the vehicle using a location sensor of the vehicle;
determining there is the presence of fog in the environment surrounding the vehicle based on the plurality of visual data;
reporting the presence of fog in the environment surrounding the vehicle to a sourced service;
determining there is not a stop sign or a traffic signal on a roadway the vehicle is operating on based on the plurality of positional data;
determining the fog present in the environment surrounding the vehicle is not "intense" based on the plurality of visual data;
determining there is not an upcoming curve on the roadway the vehicle is operating on based on the plurality of positional data;
determining a plurality of upcoming traffic conditions on the roadway the vehicle is operating on are not "intense" based on the plurality of positional data; and
initiating a fog safe response phase for the vehicle based on the determination there is not a stop sign or a traffic signal on the roadway the vehicle is operating on, the determination the fog present in the environment surrounding the vehicle is not intense, the determination there is not an upcoming curve on the roadway the vehicle is operating on, and the determination the plurality of upcoming traffic conditions on the roadway the vehicle is operating on are not intense, wherein initiating the fog safe response phase includes activating a plurality of low beam lights or a plurality of flood lights of the vehicle.

14. The method of claim 13 further comprising activating a plurality of speakers of the vehicle to alert a user of the vehicle that the vehicle is approaching either a stop sign or a traffic signal on a roadway the vehicle is operating on when determining there is either a stop sign or a traffic signal on the roadway the vehicle is operating on based on the plurality of positional data.

15. The method of claim 13 further comprising activating a plurality of hazard lights of the vehicle when determining the fog present in the environment surrounding the vehicle is "intense" based on the plurality of visual data.

16. The method of claim 13 further comprising indicating to a user of the vehicle to increase a following distance of the vehicle when determining there is either an upcoming curve on the roadway the vehicle is operating on based on the plurality of positional data or a plurality of upcoming traffic conditions on the roadway the vehicle is operating on are "intense" based on the plurality of positional data.

17. The method of claim 13 further comprising indicating to a user of the vehicle that the user should reduce a speed of the vehicle when determining there is either an upcoming curve on the roadway the vehicle is operating on based on the plurality of positional data or a plurality of upcoming traffic conditions on the roadway the vehicle is operating on are not "intense" based on the plurality of positional data.

18. (canceled)

19. The method of claim 13, wherein initiating a fog safe response phase for the vehicle further comprises indicating to a user of the vehicle that a plurality of high beam lights of the vehicle are active when the plurality of high beam lights are active and that the plurality of high beam lights should be deactivated.

20. A method for determining, pre-emptively responding to, and actively responding to a presence of fog in an environment surrounding a vehicle, the method comprising:
collecting a plurality of environmental data of the environment surrounding the vehicle using a plurality of vehicle environment sensors of the vehicle and a clock of the vehicle, the plurality of vehicle environment sensors having a plurality of temperature sensors, a location sensor, a plurality of humidity sensors, a plurality of air pressure sensors, and a plurality of cameras, wherein the plurality of temperature sensors collect a plurality of temperature data of the plurality of environmental data, the location sensor collects a plurality of positional data of the plurality of environmental data, the plurality of humidity sensors collect a plurality of humidity data of the plurality of environmental data, the plurality of air pressure sensors collect a plurality of air pressure data of the plurality of environmental data, the plurality of cameras collect a plurality of visual data of the plurality of environmental data, and the clock record a plurality of time data of the plurality of environmental data;
receiving a plurality of weather service data of the environment surrounding the vehicle from a weather service in communication with the vehicle;
receiving a plurality of sourced service data of the environment surrounding the vehicle from a sourced service in communication with the vehicle;
determining a presence of a plurality of predictive fog score factors for the vehicle having determining a relative humidity of the environment surrounding the vehicle is greater than 90% based on the plurality of humidity data, determining a drop in temperature in the environment surrounding the vehicle is greater than five degrees
Fahrenheit between the time six hours prior to the determination of the presence of the plurality of predictive fog score factors and the time of the determination of the presence of the plurality of predictive fog score factors based on the plurality of temperature data and the plurality of time data, determining a body of water is within five miles of the vehicle based on the plurality of positional data, determining an air pressure of the environment surrounding the vehicle is "low" based on the plurality of air pressure data, determining that a local time of the environment surrounding the vehicle is either between six A.M. and nine A.M. or between five P.M. and eight P.M. based on the plurality of time data, determining that a precipitation level of the environment surrounding the vehicle is greater than two tenths of an inch between the time six hours prior to the determination of the presence of the plurality of predictive fog score factors and the time of the determination of the presence of the plurality of predictive fog score factors based on the plurality of weather service data and the plurality of time data, determining a dew point temperature of the environment surrounding the vehicle is within two to four degrees Fahrenheit of a temperature of the environment surrounding the vehicle based on the plurality of temperature data and the plurality of weather service data, determining that there are either no clouds present or only scattered clouds present in the environment surrounding the vehicle based on the plurality of weather service data, determining a wind speed of the environment surrounding the vehicle is less than five miles per hour based on the plurality of weather service data, determining there is a local fog warning in the environment surrounding the vehicle based on the plurality of weather service data, determining an air pressure of the environment surrounding the vehicle is below 1010 hectopascals based on the plurality of air pressure data, and determining that the plurality of sourced service
data includes a report indicating that there is fog in the environment surrounding the vehicle, based on the plurality of environmental data, the plurality of weather service data, and the plurality of sourced service data;
determining a predictive fog score for the vehicle based on the presence of the plurality of predictive fog score factors by initializing the predictive fog score to a value of zero and adding a configurable number of points to the predictive fog score for each of the plurality of predictive fog score factors present in the environment surrounding the vehicle;
comparing the predictive fog score to a configurable threshold based on a plurality of arbitrary personal preferences of a user of the vehicle;
initiating a fog pre-emptive response phase for the vehicle in response to determining that the predictive fog score exceeds the configurable threshold, wherein the fog pre-emptive response phase includes indicating to the user of the vehicle to increase a following distance of the vehicle based on the plurality of environmental data, the plurality of weather service data, and the plurality of sourced service data, indicating to the user of the vehicle that the user should reduce a speed of the vehicle, and activating a defroster of the vehicle to prevent fog from obscuring a view of the user of the vehicle through a front windshield, a rear window, and a plurality of side windows of the vehicle;
determining there is the presence of fog in the environment surrounding the vehicle based on the plurality of visual data;
reporting the presence of fog in the environment surrounding the vehicle to the sourced service;
determining there is a stop sign or a traffic signal on a roadway the vehicle is operating on based on the plurality of positional data;
determining the fog present in the environment surrounding the vehicle is "intense" based on the plurality of visual data;
determining there is an upcoming curve on the roadway the vehicle is operating on based on the plurality of positional data;
determining a plurality of upcoming traffic conditions on the roadway the vehicle is operating on are "intense" based on the plurality of positional data; and
initiating a fog safe response phase for the vehicle based on the determination there is not a stop sign or a traffic signal on the roadway the vehicle is operating on, the determination the fog present in the environment surrounding the vehicle is not intense, the determination that there is not an upcoming curve on the roadway the vehicle is operating on, and the determination that the plurality of upcoming traffic conditions on the roadway the vehicle is operating on are not intense, wherein the fog safe response phase includes activating a plurality of low beam lights or a plurality of flood lights of the vehicle, indicating to the user of the vehicle that a plurality of high beam lights of the vehicle are active when the plurality of high beam lights are active and that the plurality of high beam lights should be deactivated,
indicating to the user of the vehicle to increase a following distance of the vehicle, indicating to the user of the vehicle that the user should reduce a speed of the vehicle, and activating a plurality of speakers of the vehicle to alert the user of the vehicle that the vehicle is approaching either a stop sign or a traffic signal on a roadway the vehicle is operating on.
